(19) United States
(12) Patent Application Publication
(10) Pub. No.: US 2017/0001370 A1
(43) Pub. Date: Jan. 5, 2017

(54) ADDITIVE-MANUFACTURING DEVICE FOR CREATING A THREE-DIMENSIONAL OBJECT, AND ASSOCIATED METHOD

(71) Applicant: Pollen AM, Paris (FR)

(72) Inventors: Cédric Michel, Paris (FR); Victor Roux, Paris (FR); Tom Lerouge, Paris (FR); David Hauser, Paris (FR)

(73) Assignee: Pollen AM, Paris (FR)

(21) Appl. No.: 15/113,136

(22) PCT Filed: Jan. 26, 2015
(86) PCT No.: PCT/EP2015/051461

§ 371 Date: Jul. 21, 2016

(30) Foreign Application Priority Data
Jan. 24, 2014 (FR) 14 50621

(51) Int. Cl. B29C 67/00; B33Y 10/00; B33Y 30/00; B29B 13/02

(52) U.S. Cl. CPC B29C 67/0059; B29C 67/0092; B29B 13/022; B33Y 10/00; B33Y 30/00

(57) ABSTRACT

The main object of the invention is an additive-manufacturing device (1) for creating a three-dimensional object (2), characterized in that it comprises a material selection unit (3), the materials including materials for the creation of the three-dimensional object (2), an induction heating unit (4) for heating the materials, the selection unit (3) being able to convey the materials toward the heating unit (4) which causes them to melt, and a material deposition unit (5) which ejects the materials after they have passed through the heating unit (4) onto a support (6) so as to allow the three-dimensional object (2) to be built up in successive layers of material.

### TECHNICAL FIELD

The present invention relates to the field of devices and methods for manufacturing a three-dimensional object by selective deposition of material in successive layers. It thus relates in particular, but not limited to, the field of three dimensional printing, also called additive manufacturing or rapid prototyping.

The invention has applications in various fields, both for industry and for a particular purpose. These areas include, in particular automotive, aerospace, medicine such as dental industry, military industry, consumer goods, jewelry, film industry, project visualization for architecture or design studies, personal use of 3D printers, or 3D printing online services.

The invention thus provides an additive manufacturing device for producing a three-dimensional object, a method of producing a three-dimensional object implemented by means of such a device, and a three-dimensional object obtained by this device or method.

### STATE OF PRIOR ART

Three-dimensional printing, also known as 3D printing is an additive manufacturing technique developed for rapid prototyping. This technique appeared in the mid 80s as a new method for producing real objects from CAD data files. CAD stands for “Computer Aided Design”. Thus, an operator draws the object on a computer screen using a CAD tool, in surface or volume mode. Then, the obtained 3D data file is sent to a specific printer which cut into slices and deposits or solidifies the material layer-by-layer in order to obtain the final object. In this way, three-dimensional printing provides a real object, typically a prototype, by stacking layers of material, without machining. The stack of layers creates the volume of the object.

Since its emergence, three-dimensional printing has given rise to different coexisting technologies. It may well include, among others, stereolithography (SLA for “Stereolithography Apparatus”), molten filament extrusion (or FDM for “Fused Deposition Modeling”), selective laser sintering (SLS for “Selective Laser Sintering”), electron beam melting (or EBM for “Electron Beam Melting”), 3DP printing (for “3D Printing”) or 3D printing by PolyJet.

In recent years, a democratization phenomenon of these technologies for individuals can be observed. This phenomenon is mainly based on SLA and FDM type methods by simplifying and miniaturizing them. However, this poses a problem because those methods have been developed in order to produce prototypes and not finished objects, suitable for consumption, without having to require a post-treatment.

In addition, these two FDM and SLA type methods are limited in terms of versatility of the materials used. Indeed, FDM type method primarily uses ABS type polymers (for “Acrylonitrile Butadiene Styrene”) or PLA (for “PolyLactic Acid”) and SLA type method mainly uses resin aqueous solutions. Some devices using these methods then respond partially to this issue of versatility of materials, adding as many printheads as supported materials, which then increases their complexity. Moreover, such devices only provide slight variations in materials, and no heterogeneous materials. However, obtaining a consumption model from an additive manufacturing device requires support of a plurality of materials (for example polyamides, ceramics, metals, etc.), which raises the problem of the adhesion of the different materials used and their structural integrity.

Moreover, these two SLA and FDM type methods are also limited in terms of reliability. Indeed, either for temperature measurement, control or diffusion, both methods require numerous and expensive components to gain precision. In particular, the thermal resistances in FDM type method involve a relative lifespan and a heavy maintenance of the device for individuals. The same goes for SLA type method with the use of laser(s) or radiative light source(s). More generally, the control of the printhead position, as critical for the precision as for proper production of a three-dimensional model, requires for both these methods a significant number of additional sensors, that add complexity and cost. Yet, to help achieve a versatile and reliable system, especially for individuals, those elements have to be controlled.

In addition, all existing technologies, with the exception of 3DP printing that uses a chemical binder to solidify the material in powder form, undertake a substantial energy consumption: thermal resistances, lasers and the like are not optimized for versatile consumer use in terms of materials.

Finally, all existing technologies require post-treatment for “cleaning” the object and perfecting it by giving it more strength, for polishing, coating or colorizing it.

All these limitations and restrictions are regrettable as harmful to the user experience, as much in the feasibility as in the result, although it is one of the main issues to develop the use and consumption of such technology.

### SUMMARY OF THE INVENTION

A need thus exists to offer a new principle of additive manufacturing with, among other things, a capacity of processing heterogeneous materials in the same process, a capacity of finishing the final object by a coating, colorized or not, still in the same process, and an awareness of the energy and chemical constraints related to a mass consumption issue.

The invention aims to at least partially overcome the above mentioned needs and disadvantages related to the prior art embodiments.

The invention purpose is, in one of its aspects, an additive manufacturing device for producing a three-dimensional object, characterized in that it comprises:

a material selection unit, including materials for producing the three-dimensional object,

an induction heating unit of materials, the selecting unit being capable of conveying the material to the heating unit that causes the melt,

a deposition material unit, which ejects the materials after they passed through the heating unit on a support, to enable the production of the three-dimensional object by successive material layers.

Thanks to the invention, it may be possible to reduce or solve all the drawbacks and problems mentioned above in connection with embodiments of the prior art. In particular, it may be possible to manufacture a three-dimensional object, and more specifically to achieve independently a complete object, which may include a plurality of materials, colorized or not, optionally with one or more coatings without having to require any subsequent processing of the object. In addition, through the use of induction heating, significant energy savings can be achieved compared to other additive manufacturing technologies using an energy source to process materials. Induction can also be used to obtain a targeting of the area to be treated because the energy is converted into heat on a specific area with a very low diffusion. In addition, the same induction heating method can be used for different materials, which receive a specific treatment according to their composition.

The device of the invention may further comprise one or more of the following features, separately or in any possible technical combinations.

The materials selection unit may include a first portion of the material packaging in capsules and a second portion of material dispensing, particularly to the induction heating unit.

The capsules may be interchangeable. The materials can be packaged in various forms, including in liquid or solid form, particularly in the form of fine powder.

The first portion of material packaging may comprise first material capsules for producing three-dimensional object, and/or second material capsules for production and/or treatment of the support, and/or third material capsules for colorization of support and/or three-dimensional object.

The second portion of material dispensing may include a first material dispenser for production of the three-dimensional object, and/or a second material dispenser for production and/or treatment of the support, and/or a third material dispenser for colorization of the support and/or the three-dimensional object.

The material selection unit can include different useful elements to the packaging and dispensing of materials, such as, for example, piezoelectric valves, humidity sensors, elements of material identification and of material age indication, among others. The induction heating unit of materials may comprise a first inductive heating portion of the materials for production of the three-dimensional object and a second inductive heating portion of the materials for production and/or treatment of the support.

The induction heating unit, and in particular the first inductive heating portion and/or the second induction heating portion may include at least one induction heating module, comprising:

a tubular insulating element, in particular thermally insulating and/or electrically,

a rod, in particular a rotatable rod, and in particular helical, located inside the tubular element,

at least one induction coil portion extending over the outer wall of the tubular element,

the materials being able to penetrate inside the tubular element in order to be brought to melt by induction heating in contact with the rod.

The tubular element may have an inner wall treated to reduce its viscosity, for example having a polytetrafluoroethylene (PTFE) coating or equivalent.

The rod may preferably be rotatable. However, the rod can also alternatively be fixed.

In the case of a rotatable helical rod, the shape of the helical rod blades may be variable, and the step may be variable

The rod may include a material which strongly reacts to magnetic fields generated by induction.

The induction heating unit may further comprise a variable speed motor connected to the rod, in particular in the case of a rotatable rod to allow its rotation, for example by means of a belt or any other drive system. The induction heating unit may also include one or more induction generators. The induction heating unit may also include a storage compartment or lock of molten forming materials in preparation for their ejection or deposition.

The induction heating unit may comprise a plurality of induction heating modules, at least two induction heating modules allowing induction heating of materials of different compositions.

The material deposition unit may comprise a first material deposition portion for production of the three-dimensional object and a second material deposition portion for production and/or treatment of the support.

The material deposition unit, particularly the first deposition portion and/or the second deposition portion may comprise at least one deposition module by generating acoustic waves. Alternatively, the material deposition unit may include a deposition module by other types of material ejection means, for example by pneumatic actuation, by pressure generation from actuation of piezoelectric cells, or by thermal excitation.

Thanks to the presence of at least one acoustic wave generation deposition module, it may be possible to pass from a drop-on-demand material ejection mode (ie in the form of droplets) to a continuous ejection flow, and vice versa, as specified hereinafter. Besides, it may be possible to adjust the material volume to be deposited on the support by controlling the acoustic wave frequency and amplitude. In addition, it may be possible to interact without contact with the various materials used to produce the three dimensional object and/or the support. Finally, it may be possible to determine on the go the position of the device printhead, comprising the induction heating unit and the deposition unit, relatively to the support.

Advantageously, the material deposition unit comprises a plurality of acoustic wave generation deposition modules. These acoustic wave generation deposition modules may be modular.

The acoustic waves generation deposition module or modules may be located in the molten forming material storage compartment or lock of the induction heating unit.

The acoustic waves generation deposition module or modules may comprise piezoelectric transducers, optionally associated with Fresnel multifocal zones depending on the viscosity of the molten forming material in fluid form to be treated.

Piezoelectric transducers can act both as variables acoustic transmitters and as acoustic receivers.

The material deposition unit may comprise at least one extrusion orifice, in particular as many extrusion orifices as acoustic wave generation deposition modules, through which the molten forming material is ejected pushed under the influence of the aforementioned at least one acoustic waves generation deposition module.

The size of the aforementioned at least one extrusion orifice may be less than the flowing capacity of the molten forming material in fluid form.

The aforementioned at least one acoustic waves generation deposition module may be able to allow continuous or droplet material deposition.

The acoustic waves generation deposition module or modules, associated to one or more extrusion orifices of molten forming material, can function as follows: a signal received by an acoustic waves generation deposition module generates an acoustic wave which builds up a pressure on the molten forming material, forcing it to pass through an extrusion orifice associated to this acoustic waves generation deposition module.

The signal received by the acoustic waves generation deposition module may be sent by a computer control system (or control electronics) of the additive manufacturing device according to the invention. The control by this computer control system of signals sent to the acoustic wave generation deposition module may allow to select one or more extrusion orifices, and so control the ejected molten forming material flow and volume.

The device may also comprise flow and/or material temperature control elements, particularly in the form of alternating current sources.

The device may further comprise a computer control system for communication with a CAD tool and device operation control.

The invention also relates, according to another of its aspects, to a method for producing three-dimensional objects by additive manufacturing, characterized in that it is implemented by means of a device as defined above, and in that it comprises in particular one or more of the following steps:

selective conveying of materials from the selection unit down to the heating unit, especially through at least one material dispenser,

selective heating of materials by the heating unit until the materials are melting,

using at least one rod, in particular of at least one rotatable rod, and in particular helical, for induction heating and material flow control,

droplet or continuous deposition of the molten forming material by the deposition unit on the support,

cooling of the deposited material,

moving the support relatively to the deposition unit to allow deposition of successive layers of material,

production of a multi-material three-dimensional object by use of capsules of different materials, heated up to different temperatures by the heating unit,

treatment of the support by means of the material deposition unit to impart it coating properties, including adhesion and/or colorization.

The invention also relates to, according to another of its aspects, an additive manufacturing three-dimensional object, characterized in that it is obtained by a device as defined above or a method as defined above.

In addition, the invention also provides, in another of its aspects, an additive manufacturing three-dimensional object characterized in that it comprises:

a material selection unit, including materials for producing the three-dimensional object,

a material heating unit, the selection unit being capable of conveying the material down to the heating unit,

a material deposition unit including at least one acoustic wave generation deposition module, which ejects the material that passed through the heating unit on a support, to enable the production of the three-dimensional object by successive material layers.

The aforementioned characteristics for the additive manufacturing device, the method and the three-dimensional object according to the invention may be taken separately or in any technically possible combination with other features.

### BRIEF DESCRIPTIONS OF THE DRAWINGS

The invention will be better understood by reading the detailed description that follows, a non-limiting example of implementation of it, and the review of the figures, schematic and partial, of the drawing in the annex, on which:

FIG. 1 illustrates, in block diagram form, an example of an installation comprising an additive manufacturing device according to the invention,

FIG. 2 shows in more detail the material selection unit of the additive manufacturing device of FIG. 1,

FIG. 3 is a further detailed representation of the material selection unit and of the printhead, including the heating unit and the deposition unit, of the additive manufacturing device of FIG. 1,

FIG. 4 shows, in section, an example of an additive manufacturing device heating unit according to the invention similar to that of FIG. 1,

FIG. 5 shows, in top view, the heating unit of FIG. 4 and the additive manufacturing device deposition unit according to the invention, and

FIG. 6 shows, in partial section and in perspective, an example of induction heating module of the heating unit of FIG. 4.

In all these figures, identical references may designate identical or similar elements.

Furthermore, the different parts represented in the figures are not necessarily to a uniform scale, in order to make the figures more understandable.

### DETAILED DESCRIPTION OF A PARTICULAR EMBODIMENT

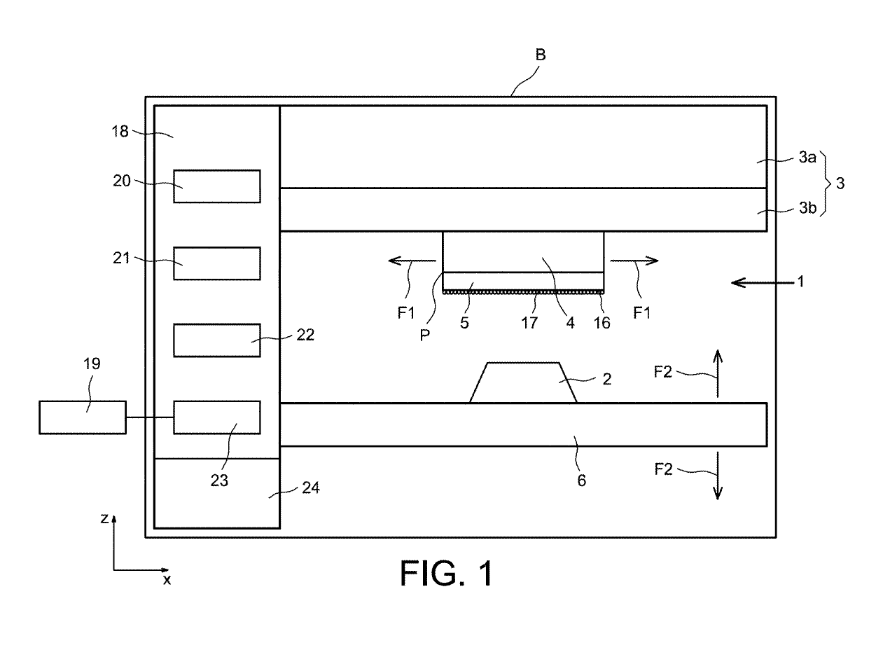

FIG. 1 illustrates, in the form of a block diagram, an example of an installation comprising a device 1 of additive manufacture according to the invention.

The installation looks for example in the form of a box B, which comprises in particular the device 1 of additive manufacture according to the invention, a support 6 on which a three-dimensional object 2 is intended to be manufactured and a computer control system 18 for communication with a CAD tool 19 and control the operation of the device 1.

The CAD tool 19 can be used to design by computer a slicing plane of a three-dimensional model, which can take into account of a variety of materials, and which may subsequently be produced through the device and method according to the invention.

According to the invention, the device 1 comprises an additive manufacturing selecting unit 3 of materials, including materials for producing the three-dimensional object 2, an induction heating unit 4 of the materials, the selection unit 3 being able to convey the materials down to the heating unit 4 which causes their melt, and a deposition unit 5 of materials, which ejects the materials after passing through the heater unit 4 on the support 6, to allow production of the three-dimensional object 2 by deposition of successive layers of materials.

Specifically, the selection unit 3 of material comprises a first portion 3a of material packaging and a second portion 3b of material dispensing, in particular to the induction heating unit 4. Thus, the selection unit 3 of materials may allow the selection of the material(s) required to produce the three-dimensional object 2 and/or modify the support 6, and convey them to the induction heating unit 4.

Moreover, the induction heating unit 4 and the deposition unit 5 of materials are contained in a printhead P of the device 1 according to the invention, which is capable of moving horizontally along the arrows F1 along the horizontal axis X, in order to eject the molten forming material from the induction heating unit 4 to the support 6 at the desired locations.

Moreover, the support 6, on which is positioned the three-dimensional object 2 to be manufactured, is also capable of moving vertically according to the arrows F2, along the vertical axis Z, in order to adjust its distance with respect to the printhead P during the deposition of successive layers of material.

The computer control system 18 is in turn connected to the various elements and units of the device 1 according to the invention, enabling to allow control and communication between those elements, and in particular to ensure the manufacture of the three-dimensional object 2 and the possible finishing of the support 6.

Thus, the computer control system 18 may for example comprise a computer 20 associated with a processing software 21 and an internal memory 22, and a communication device 23 connected to the external CAD system 19 allowing transfer of a computer file associated with the three-dimensional object 2 to be produced. Moreover, an energy source 24 may be incorporated into this computer control system 18.

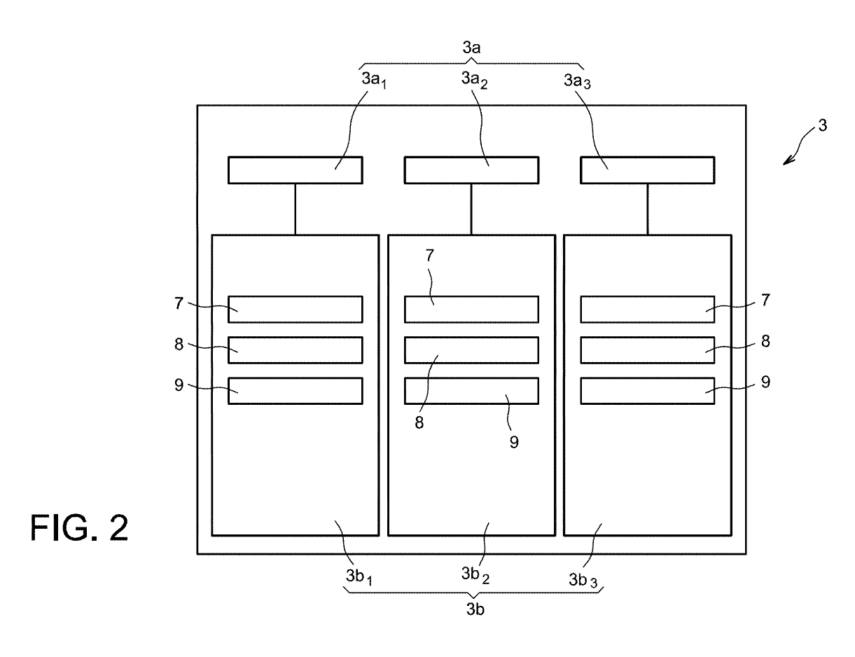

The selection unit 3 of materials of the additive manufacturing device of FIG. 1 is represented in more detail in FIG. 2.

As indicated above, the selection unit 3 of material comprises a first portion 3a of material packaging and a second portion 3b of material dispensing. The first portion 3a of packaging materials includes 3a₁, 3a₂ and 3a₃ capsules of materials and the second portion 3b of dispensing comprises 3b₁, 3b₂ and 3b₃ dispensers of materials. More precisely, the first portion 3a of material packaging comprises first capsules 3a₁ of materials for the production of the three-dimensional object 2, second capsules 3a₂ of materials that allow the production and/or treatment or finish of the support 6, and third 3a₃ capsule materials that can enable colorization of the support 6 and/or of the three-dimensional object 2.

According to the needs for producing the three-dimensional object 2 and the possible finishing of the support 6, such materials capsules are brought to the dispenser of materials of the second part 3b of dispensing. This second part 3b of materials dispensing comprises a first dispenser 3b₁ of materials for production of the three-dimensional object 2, a second dispenser 3b₂ of materials for production and/or treatment of the support 6, and a third dispenser 3b₃ of materials to allow possible colorization of the support 6 and/or the three-dimensional object 2. Each of the first 3b₁, second 3b₂ and third 3b₃ material dispensers include various elements allowing them to achieve conveying of the materials capsule from the selection unit 3 to the induction heating unit 4, these elements comprising in particular valves 7, flow control elements 8 and 9 and conveying ducts, in particular flexible.

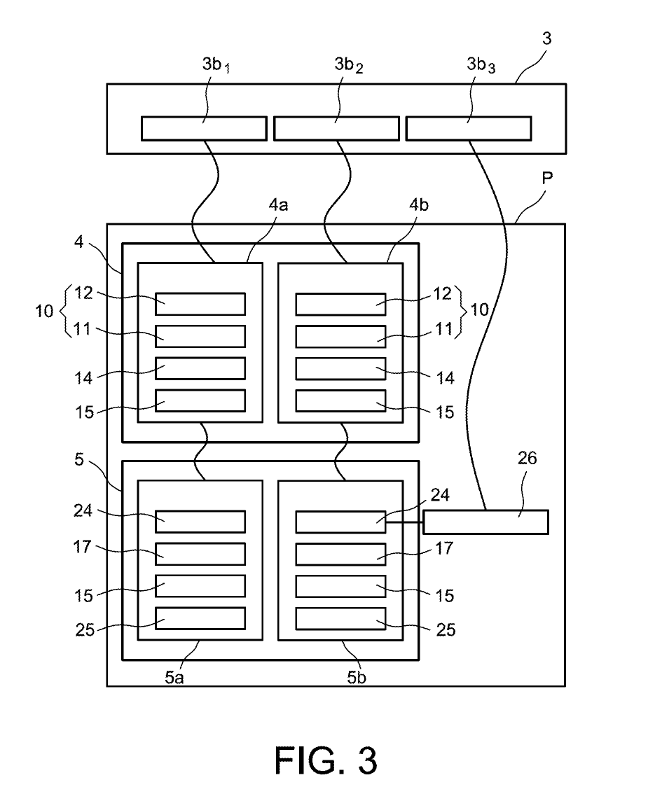

In FIG. 3 will now be described another detailed view of the selection unit 3 of materials and of the printhead P, which comprises the induction heating unit 4 and the deposition unit 5 of the additive manufacturing device 1 of FIG. 1.

As can be seen from FIG. 3, the induction heating unit 4 of the materials comprises a first induction heating portion 4a of materials for the production of the three-dimensional object 2 and a second induction heating portion 4b of materials for production and/or treatment of the support 6.

More particularly, the first material dispenser 3b₁ of the selection unit 3 is connected to the first induction heating portion 4a of the induction heating unit 4, and the second material dispenser 3b₂ of the selection unit 3 is connected to the second induction heating portion 4b of the induction heating unit 4.

Each of the first portion 4a and second portion 4b of induction heating also comprises control elements causing the material to melt and controlling the proper operation of induction heating. These control elements comprise for example a temperature control element 14 and a material flow control element 15.

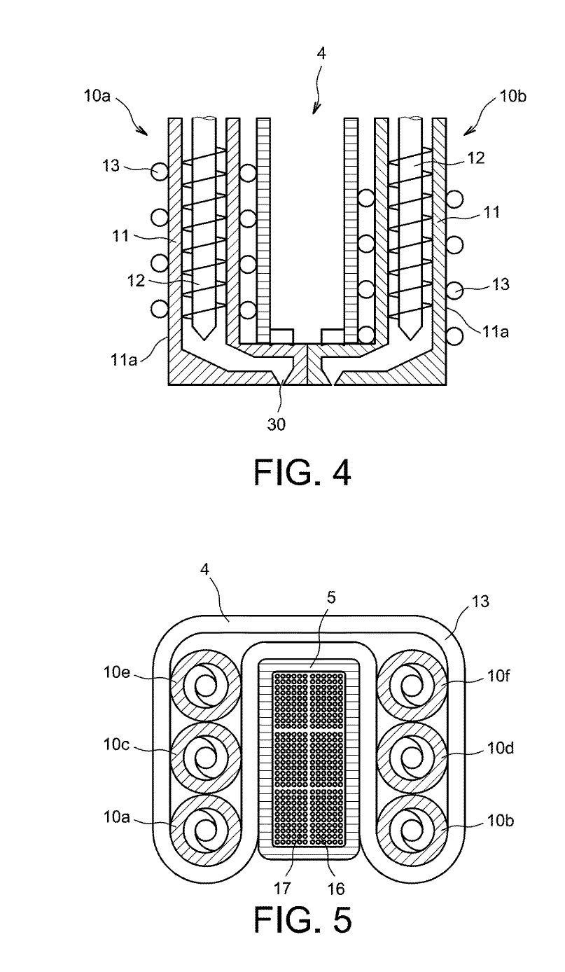

Furthermore, each of the first portion 4a and second portion 4b of induction heating comprises at least one induction heating module 10, as will be described subsequently with reference to FIGS. 4 to 6.

Furthermore, FIG. 3 also shows in more detail the deposition unit 5 of materials, which allows ejection of the molten forming material after passing through the heating unit 4 on the support 6.

Advantageously, the deposition unit 5 of materials allows ejection of the molten forming material through acoustic wave generation. More specifically, the deposition unit 5 of materials comprises a first deposition portion 5a of the materials for production of the three-dimensional object 2 and a second deposition portion 5b of materials for production of materials for production and/or treatment of the support 6.

Each of the first portion 5a and second portion 5b of material deposition comprises at least one acoustic wave generation deposition module 17, which may be interconnected as shown. The operation of these acoustic wave generation deposition modules 17 will be described later.

Furthermore, each of the first deposition portion 5a and second deposition portion 5b of materials may include a plurality of elements required for proper operation of the molten forming material ejection on the support 6, and for example control elements such as material flow control elements 15, similar to those described for the induction heating unit 4. In addition, ejection chambers 24 and assistance elements for the deposition of the molten forming material 25 may be present.

Furthermore, the invention proposing to perform the possible treatment of the support 6 in order to obtain, if necessary, a finished three-dimensional object 2, in other words usable without requiring a post-treatment, the production and/or modification of the support 6 may be performed through the second dispenser 3b₂ of material, connected to the second heating portion 4b itself connected to the second deposition portion 5b. In addition to this process, the third dispenser 3b₃ of the third capsules 3a₃ of materials may be connected directly to a selective injection device of colorization materials 26, integrated in the printhead P and directly connected to the second deposition portion 5b of the deposition unit 5, and more particularly to an ejection chamber 24 of this second deposition portion 5b. In the implementation of the colorization of the support 6, various solutions may be considered such as the use of selective heat, of a radiation, or of a reactive agent in colorized solutions.

Now will be described in even more details the induction heating unit 4 and the deposition unit 5 of the additive manufacturing device 1 according to the invention, with reference to FIGS. 4 to 6.

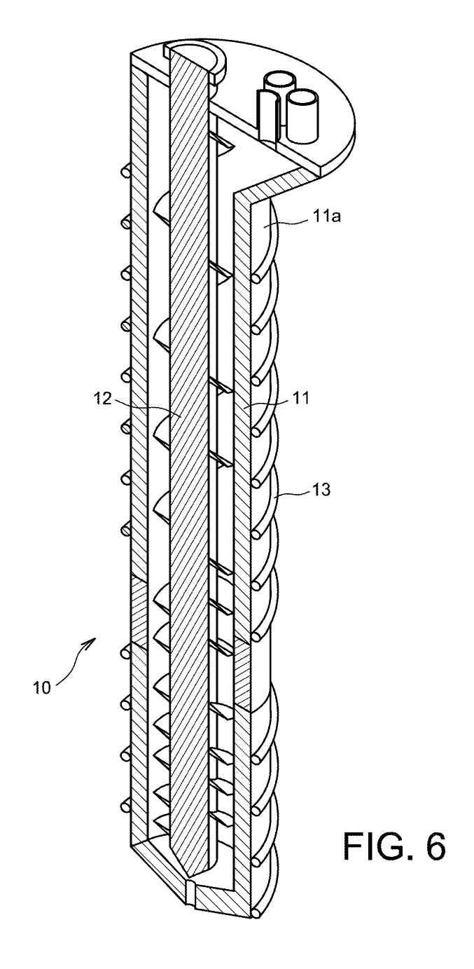

Specifically, FIG. 4 shows, in section, an example of induction heating unit 4 of the additive manufacturing device 1 according to the invention. FIG. 5 shows, in top view, the induction heating unit 4 of FIG. 4 and the deposition unit 5 of the additive manufacturing device 1 according to the invention, and FIG. 6 shows, in partial section and in perspective, an example of a module 10 of induction heating unit of the heating unit 4 of FIG. 4.

As can be seen by comparison of FIGS. 4, 5 and 6, the induction heating unit 4 may comprise for example six induction heating modules 10a-10f. Obviously, the number of induction heating modules of the heating unit 4 is nonlimiting and can be determined according to the needs for production of the three-dimensional object 3 and/or production or modification of the support 6. Likewise, the additive manufacturing device 1 according to the invention may, alternatively, comprise a plurality of induction heating units 4 associated with a plurality of deposition units 5 of molten forming material.

Each induction heating module 10a-10f has a tubular element 11, thermally and/or electrically insulating, wherein the material to be treated is introduced, for example in powder, liquid or solid form. This tubular element 11 preferably has a treated inner wall, possibly being made with PTFE, in order to reduce the viscosity.

Moreover, each induction heating module 10a-10f comprises a rotatable rod 12, in particular in a helical shape, which is located inside the tubular element 11. The helical rod 12 can have blades of varying shape and be composed of a material which strongly reacts to induction-generated magnetic fields. This helical rod 12 serves as drive means of the materials introduced into the tubular element 11 towards a storage compartment or lock 30 of the molten forming material, heated in contact with the helical rod 12.

Besides, each induction heating module 10a-10f comprises at least one induction coil portion 13 which extends on the outer wall 11a of the tubular element 11.

More precisely, as can be seen on FIG. 5, a single induction coil 13 can extend all around the six induction heating modules 10a-10f, and in particular on the outer wall 11a of the tubular elements 11. Furthermore several induction coils 13 may be superimposed on each other along the induction heating modules 10a-10f, as shown on FIGS. 4 and 6.

Moreover, the induction heating unit 4 may also comprise one or more variable speed motors connected the helical rod(s) 12 by means of a belt or any other driving system to enable rotation of the rods 12, and also one or more induction generator(s), not shown.

Advantageously, the use of a plurality of induction heating modules 10a-10f, thus comprising a plurality of helical rods 12, all subject to the same induction process, may allow to use a composition of different materials in each induction heating module 10a-10f which, subjected to induction-generated magnetic fields, can achieve different temperatures, depending on the materials that are present in the tubular elements 11.

Furthermore, FIG. 5 shows the deposition unit 5, positioned for example in the lock 30 of the heating unit 4. As shown in FIG. 5, the deposition unit 5 may comprise a plurality of acoustic waves generation deposition modules 17, associated to a plurality of extrusion orifices 16 through which the molten forming material is ejected, pushed under the influence of acoustic waves generated by the deposition modules 17.

The extrusion orifices 16 may advantageously have a size smaller than the flow capacity of the molten forming material in fluid form. The acoustic wave generation deposition modules 17 may in particularly consist of piezoelectric transducers, optionally associated with multifocal Fresnel zones depending on the viscosity of the molten fluid to be treated, and can act both as variable acoustic transmitters and acoustic receivers.

To allow ejection of the molten forming material by the deposition unit 5 on the support 6, the operation of the acoustic waves deposition is as follows: a signal, for example emitted by the computer control system 18, received by one of the acoustic wave generation deposition modules 17 generates an acoustic wave which develops a pressure on the molten forming material, thus forcing it to pass through an extrusion orifice 16 associated with this acoustic wave generation deposition module 17.

Computer control, and in particular through the computer control system 18 of the different signals sent to the different acoustic wave generation deposition modules 17 may allow to select one or more extrusion orifices 16 as required, and control the flow and volume of ejected materials.

Furthermore, the use of piezoelectric transducers in acoustic wave generation deposition modules 17 may allow identification and control in real time of the printhead P vertical position, along the vertical axis Z as shown in FIG. 1.

In addition, the selective deposition of the molten forming material by means of acoustic waves from the deposition unit 5 can enable considering a drop-on-demand deposition, in droplets form, or in continuous flow of the material on the support 6, the switching from one to another of these two flowing modes being simplified.

The additive manufacturing device 1 according to the invention, as described above, can provide the desired three-dimensional object 2 based on the data of the CAD tool 19.

Advantageously, the invention can thus help to avoid the use of post-processing of the finished three-dimensional object 2. It authorizes the simplified production of a multi-material finished object and can provide autonomous finishes.

Obviously, the invention is not limited to the production example which has just been described. Various modifications may be made by those skilled in the art.

The term “comprising a” should be understood as being synonymous with “comprising at least one”, unless otherwise specified.

What is claimed is:

1. A device (1) of additive manufacture for producing a three-dimensional object (2), characterized in that it comprises:
a selection unit (3) of materials, including materials for producing the three-dimensional object (2),
an induction heating unit (4) of the materials, the selection unit (3) being able to convey the materials down to the heating unit (4) which causes them to melt,
a deposition unit (5) of materials, which ejects the materials after they passed through the heating unit (4) on a support (6) to allow the production of the three-dimensional object (2) in successive material layers, the said deposition unit (5) of the materials comprising at least one acoustic waves generation deposition module (17).

2. Device according to claim 1, characterized in that the selection unit (3) of material comprises a first portion (3a) of material packaging in capsules (3a₁, 3a₂, 3a₃) and a second portion (3b) of material dispensing, particularly to the induction heating unit (4).

3. Device according to claim 2, characterized in that the second portion (3b) of material dispensing comprises a first dispenser (3b₁) of materials for production of the three-dimensional object (2), and/or a second dispenser (3b₂) of materials for production and/or treatment of the support (6) and/or a third dispenser (3b₃) of colorization materials for the support (6) and/or the three-dimensional object (2).

4. Device according to claim 1, characterized in that the induction heating unit (4) of materials comprises a first inductive heating portion (4a) of the materials for production of the three-dimensional object (2) and a second inductive heating portion (4b) of the materials for production and/or treatment of the support (6).

5. Device according to claim 1, characterized in that the induction heating unit (4), and in particular the first portion of induction heating (4a) and/or the portion of induction heating (4b) comprises at least one induction heating module (10; 10a-10f), comprising:
an insulating tubular element (11), in particular thermally and/or electrically,
a rod (12), particularly a rotatable rod (12) and in particular helical, located inside the tubular element (11),
at least a portion of induction coil (13) extending on the outer wall (11a) of the tubular element (11),
the materials being able to penetrate inside the tubular element (11) to be brought to melt by induction heating in contact with the rod (12).

6. Device according to claim 5, characterized in that the induction heating unit (4) comprises a plurality of induction heating modules (10a-10f), at least two of the induction heating modules (10a-10f) allowing induction heating of materials of different compositions.

7. Device according to claim 1, characterized in that the deposition unit (5) comprises a first deposition portion (5a) of the materials for production of three-dimensional object (2) and a second deposition portion (5b) of the materials for production and/or treatment of the support (6).

8. Device according to claim 7, characterized in that the first deposition portion (5a) and/or the second deposition portion (5b) comprises at least one acoustic wave generation deposition module (17).

9. Device according to claim 1, characterized in that the deposition unit (5) of materials comprises at least one extrusion orifice (16), including as many extrusion orifices (16) as acoustic wave generation deposition modules (17) through which the ejected molten forming material is pushed under the influence of the said at least one acoustic wave generation deposition module (17).

10. Device according to claim 1, characterized in that the said at least one acoustic generation deposition module wave (17) is able to allow continuous deposition of material or in droplets.

11. A method of producing a three-dimensional object by additive manufacturing, characterized in that it is implemented by means of a device (1) according to claim 1, and in that it includes in particular one or more of the following steps:
selective conveying of the materials from the selection unit (3) to the heating unit (4), particularly by means of at least one material dispenser (3b₁, 3b₂, 3b₃),
selective heating of materials by the heating unit (4) up to the melting of materials,
use of at least one rod (12), in particular at least one rotatable rod (12) and in particular helical, for induction heating and control of the material flow,
deposition as droplets or continuously from the molten forming materials by the deposition unit (5) on the support (6),
cooling of the deposited material,
moving the support (6) relatively to the deposition unit (5) to allow the deposition of successive layers of material,
production of the three-dimensional multi-material object (2) by use of capsules (3a₁, 3a₂, 3a₃) of different materials, heated up to different temperatures by the heating unit (4),
treatment of the support (6) through the deposition unit (5) of materials to impart it coating properties, including adhesion and/or colorization properties.
